(19) United States
(12) Patent Application Publication
(10) Pub. No.: US 2026/0296822 A1
(43) Pub. Date: Oct. 1, 2026

(54) AUTOMATIC FEEDING APPARATUS FOR BAND-SHAPED SHEET

(71) Applicant: SK On Co., Ltd., Seoul (KR)

(72) Inventors: Jae Hyeok YU, Daejeon (KR); Eun Sol KO, Daejeon (KR)

(21) Appl. No.: 19/578,881

(22) Filed: Mar. 26, 2026

(30) Foreign Application Priority Data
Mar. 28, 2025 (KR) 10-2025-0040511

(51) Int. Cl. B65H 19/18; B65H 19/14

(52) U.S. Cl. CPC B65H 19/1852; B65H 19/14; B65H 2301/4621; B65H 2301/46326; B65H 2301/4634; B65H 2301/46412

(57) ABSTRACT

Proposed is an automatic feeding apparatus for a band-shaped sheet. The automatic feeding apparatus for a band-shaped sheet includes an unwinding unit configured to feed band-shaped sheets wound on a plurality of feeding reels, a splicing unit configured to interconnect a first band-shaped sheet wound on an unwinding feeding reel that is unwinding among the plurality of feeding reels and a second band-shaped sheet wound on a standby feeding reel that is on standby for unwinding, a rewinding unit configured to take up a band-shaped sheet that is continuously fed by the splicing unit, and a buffer unit disposed between the splicing unit and the rewinding unit and configured to continuously guide the band-shaped sheet that is fed from the splicing unit to a downstream side at a predetermined speed.

### CROSS REFERENCE TO RELATED APPLICATION

The present application claims priority to Korean Patent Applications No.10-2025-0040511, filed Mar. 28, 2025, the entire contents of which are incorporated herein for all purposes by this reference.

### BACKGROUND

### Technical Field

The present disclosure relates to an automatic feeding apparatus for a band-shaped sheet and, more particularly, to an automatic feeding apparatus for a wiping sheet that wipes off an electrolyte remaining on an electrolyte injection nozzle.

### Description of the Related Art

A secondary battery, which is a battery capable of being repeatedly charged and discharged, is widely applied as a power source for portable electronic communication devices such as a mobile phone and a notebook computer, along with the development of the information communication and display industries. Further, as interest in environmental issues has recently increased, active research has been conducted on eco-friendly transport means such as an electric vehicle (EV) and a hybrid electric vehicles (HEV) that can replace vehicles using fossil fuels, and demand for secondary batteries as power sources for such eco-friendly transportation vehicles is on the rise.

A secondary battery, for example, a lithium secondary battery, is typically manufactured by inserting an electrode assembly including a positive electrode plate, a negative electrode plate, and a separator inserted between the positive electrode plate and the negative electrode plate into a battery case, and then sealing the battery case by welding a cap plate to an open surface of the battery case with the electrode assembly inserted therein. Then, an electrolyte is injected into the battery case through an injection port installed in the cap plate. Such an electrolyte serves to provide a migration path of lithium ions to facilitate a smooth battery reaction, and excellent battery performance can be achieved only when the positive electrode plate, the negative electrode plate, and the separator are sufficiently impregnated with the electrolyte.

As described above, an electrolyte is injected into the battery case after an electrolyte injection nozzle is brought into close contact with an injection port provided in the battery case. After the injection is completed, the electrolyte remaining on the electrolyte injection nozzle hardens, thereby clogging the electrolyte injection nozzle and making it impossible to ensure a reliable electrolyte discharge process. Further, when the electrolyte remaining on the electrolyte injection nozzle adheres to an electrode tab, deterioration of battery lifetime may be caused by welding defects and oxidation of a welded portion.

In general, an electrolyte injection nozzle can be maintained in a clean state by wiping off it with a wiping sheet capable of absorbing electrolyte. A wiping sheet can remove (or clean) electrolyte adhering to an electrolyte injection nozzle by coming into contact with the electrolyte injection nozzle while it is transferred from a feeding reel to a take-up reel. As is known to those skilled in the art, when the wiping sheet of the feeding reel is exhausted, the cleaning process is inevitably temporarily interrupted while the feeding reel is replaced with a new one.

Accordingly, there has been a demand for a solution capable of continuously feeding a wiping sheet without interrupting a cleaning process, but satisfactory results have not yet been achieved.

### Related Art Document

### Patent Document

Korean Patent Application Publication No. 10-2024-0025771

### SUMMARY

According to an aspect of the present disclosure, an apparatus that continuously feeds a band-shaped sheet from a plurality of feeding reels can be provided.

An automatic feeding apparatus for a band-shaped sheet according to an embodiment of the present disclosure includes: an unwinding unit configured to feed band-shaped sheets wound on a plurality of feeding reels; a splicing unit configured to interconnect a first band-shaped sheet wound on an unwinding feeding reel that is unwinding among the plurality of feeding reels and a second band-shaped sheet wound on a standby feeding reel that is on standby for unwinding; a rewinding unit configured to take up a band-shaped sheet that is continuously fed by the splicing unit; and a buffer unit disposed between the splicing unit and the rewinding unit and configured to continuously guide the band-shaped sheet that is fed from the splicing unit to a downstream side at a predetermined speed.

In an embodiment of the present disclosure, the buffer unit may include fixed rollers, and movable rollers disposed to be displaceable relative to fixed rollers.

In an embodiment of the present disclosure, the fixed rollers may be disposed to be spaced apart from each other along a traveling direction of the band-shaped sheet. Further, the movable rollers may be positioned between the fixed rollers and may be disposed to be capable of reciprocating in a direction perpendicular to an arrangement direction of the fixed rollers.

The automatic feeding apparatus may further include a cleaning unit configured to bring the band-shaped sheet transferred from the splicing unit to the rewinding unit into contact with an electrolyte injection nozzle.

Further, the band-shaped sheet may include a wiping sheet configured to wipe the electrolyte injection nozzle.

In an embodiment of the present disclosure, the splicing unit may be configured to join a terminal end of the first band-shaped sheet unwound from the unwinding feeding reel and a start end of the second band-shaped sheet unwound from the standby feeding reel through high-temperature heating.

In an embodiment of the present disclosure, the splicing unit may be configured to join a terminal end of the first band-shaped sheet unwound from the unwinding feeding reel and a start end of the second band-shaped sheet unwound from the standby feeding reel through needle punching.

In an embodiment of the present disclosure, the unwinding unit may include: a first transfer roller configured to guide the first band-shaped sheet unwound from the unwinding feeding reel to the splicing unit; a second transfer roller configured to guide the second band-shaped sheet unwound from the standby feeding reel to the splicing unit; and a sensor disposed adjacent to the first and second transfer rollers.

In the automatic feeding apparatus, a guide unit configured to guide movement of the first band-shaped sheet and the second band-shaped sheet may be additionally disposed between the unwinding unit and the splicing unit.

Features and advantages of the present disclosure will be made clearer from the following detailed description based on accompanying drawings.

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the disclosure.

According to an embodiment of the present disclosure, a band-shaped sheet can be smoothly and continuously fed without interruption of feeding.

Further, the present disclosure is designed to be able to continuously feed a band-shaped sheet to a subsequent process, for example, a cleaning process, even while a first band-shaped sheet in use and another band-shaped sheet on standby are subjected to a splicing process.

Accordingly, the present disclosure provides an effect of reducing overall operation loss in that the cleaning process can be continuously performed without being stopped during the splicing process.

### BRIEF DESCRIPTION OF THE DRAWINGS

FIG. 1 is a schematic configuration diagram illustrating an automatic feeding apparatus for a band-shaped sheet according to an embodiment of the present disclosure;

FIG. 2 is a perspective view schematically illustrating a guide unit illustrated in FIG. 1;

FIG. 3 is a diagram schematically illustrating a splicing unit illustrated in FIG. 1;

FIG. 4 is a diagram schematically illustrating another example of the splicing unit; and

FIG. 5 is a diagram illustrating a process of continuously feeding a band-shaped sheet using an automatic feeding apparatus for a band-shaped sheet according to an embodiment of the present disclosure.

### DETAILED DESCRIPTION

Terms that are used to describe an embodiment of the present disclosure are not intended to limit the present disclosure. It should be noted that singular expressions include plural expressions unless stated otherwise in the contexts.

In assigning reference numerals to components in the drawings, the same components are given the same reference numerals as much as possible even when they are shown in different drawings, and similar reference numerals are given to similar components.

Drawings may be schematically shown or may be exaggerated to describe embodiments. In the specification, expressions such as “have”, “may have”, “include”, or “may include” indicate existence of corresponding characteristics (e.g., a number, a function, an operation, or a component such as a part) without excluding existence of additional characteristics.

Terms “one”, “other”, “another”, “first”, “second”, etc. are used to discriminate one component from another component and the components are not limited to the terms.

Hereinafter, an embodiment of the present disclosure is described in detail with reference to the accompanying drawings.

The present disclosure relates to an automatic feeding apparatus for a band-shaped sheet, and in other words, is configured to be able to continuously feed a band-shaped sheet without interruption by improving a feeding method of a band-shaped sheet.

The “band-shaped sheet” described in the specification may be a wiping sheet required for manufacturing a secondary battery, and is not limited thereto, and may also be configured as a sheet structure that can be wound on and fed from a reel, such as a wiping sheet.

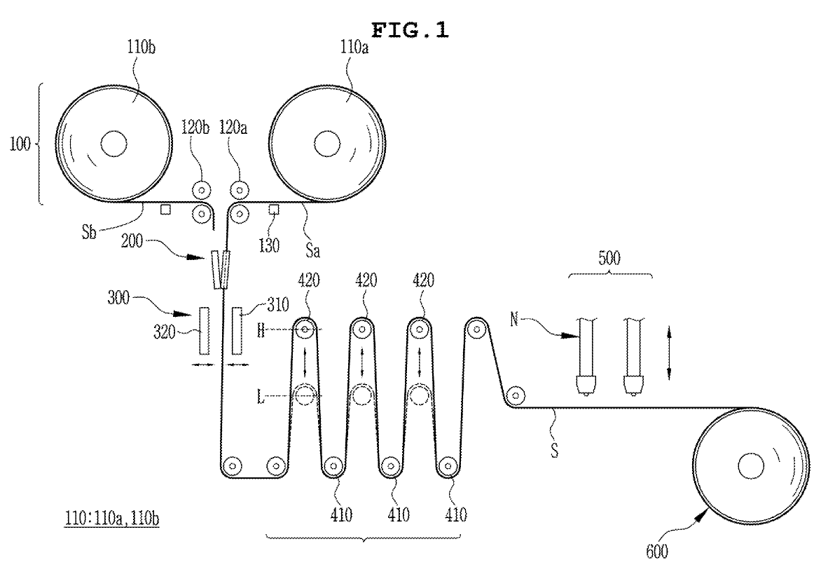

An automatic feeding apparatus for a band-shaped sheet according to an embodiment of the present disclosure is described with reference to FIGS. 1-5.

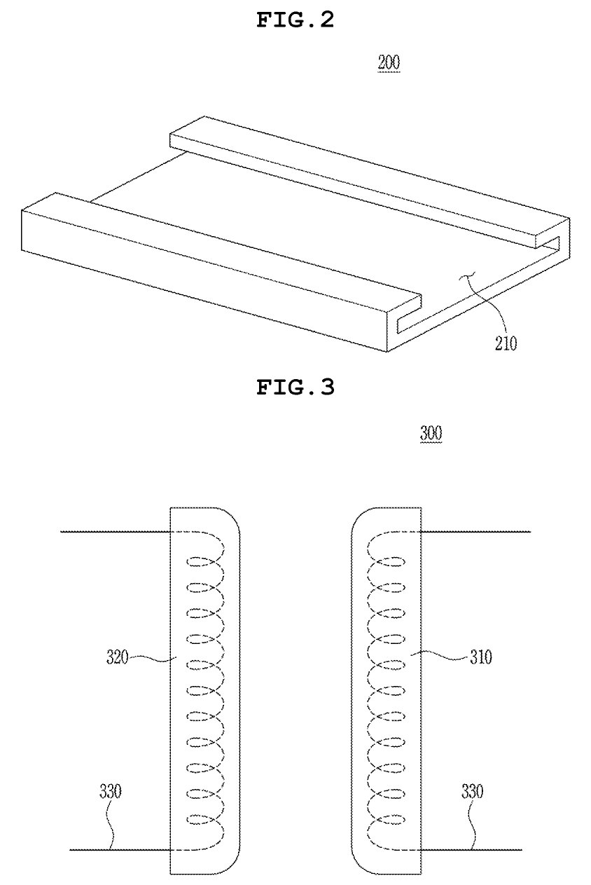

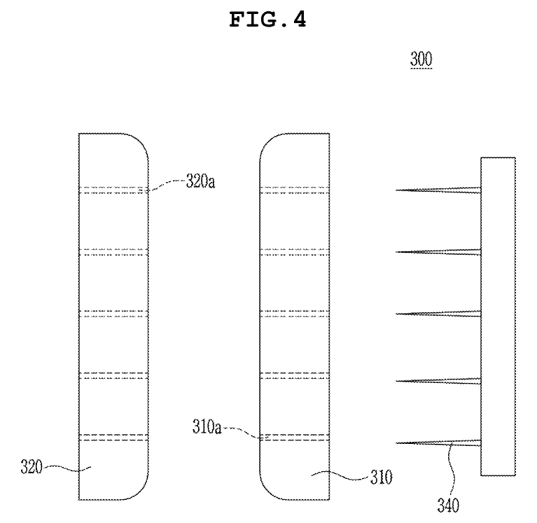

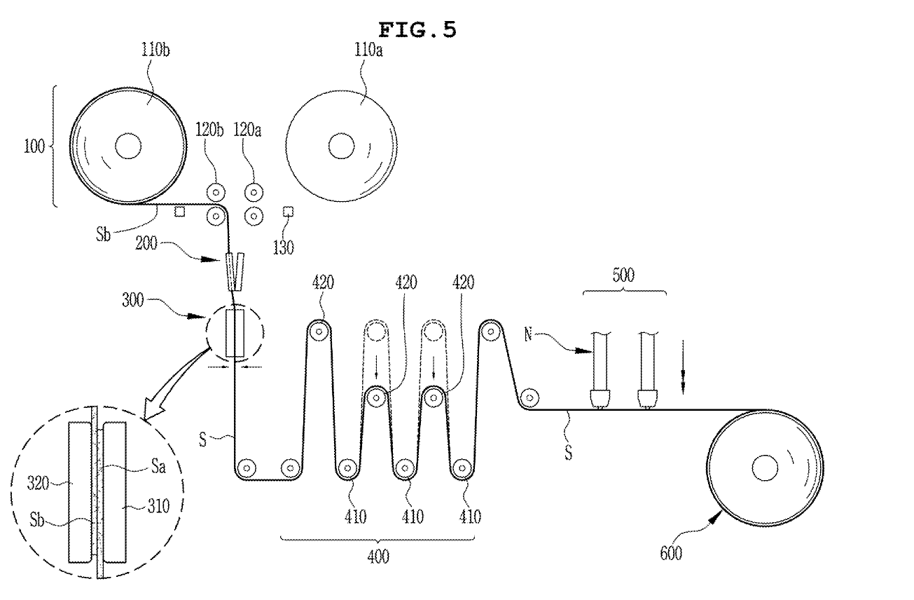

FIG. 1 is a schematic configuration diagram illustrating an automatic feeding apparatus for a band-shaped sheet according to an embodiment of the present disclosure, FIG. 2 is a perspective view schematically illustrating a guide unit illustrated in FIG. 1, FIG. 3 is a diagram schematically illustrating a splicing unit illustrated in FIG. 1, FIG. 4 is a diagram schematically illustrating another example of the splicing unit, and FIG. 5 is a diagram illustrating a process of continuously feeding a band-shaped sheet using an automatic feeding apparatus for a band-shaped sheet according to an embodiment of the present disclosure.

An automatic feeding apparatus for a band-shaped sheet according to an embodiment of the present disclosure (hereinafter, referred to as an automatic feeding apparatus) is configured, as illustrated, to continuously feed a band-shaped sheet in a reel-to-reel method.

As illustrated in FIG. 1, an automatic feeding apparatus according to an embodiment of the present disclosure may include: an unwinding unit 100 that feeds band-shaped sheets wound on a plurality of feeding reels 110; a splicing unit 300 that interconnects a first band-shaped sheet Sa wound on an unwinding feeding reel 110a that is unwinding among the plurality of feeding reels 110 and a second band-shaped sheet Sb wound on a standby feeding reel 110b that is on standby for unwinding; a rewinding unit 600 that takes up a band-shaped sheet that is continuously fed by the splicing unit 300; and a buffer unit 400 that is disposed between the splicing unit 300 and the rewinding unit 600 and continuously guides a band-shaped sheet S that is fed from the splicing unit 300 to a downstream side (a subsequent process) at a predetermined speed.

In this specification, the band-shaped sheet S may be a first band-shaped sheet Sa in use, or may be a linearly lengthened component formed by splicing a start end of a new second band-shaped sheet Sb to a terminal end of the first band-shaped sheet Sa in use.

The automatic feeding apparatus according to an embodiment of the present disclosure includes, for example, an unwinding unit 100 that feeds a band-shaped sheet S (Sa, Sb) for cleaning an electrolyte injection nozzle N.

The unwinding unit 100 is configured to draw out band-shaped sheets Sa and Sb wound on a plurality of feeding reels 110 (110a, 110b) and feed the band-shaped sheets downstream.

As illustrated, in the unwinding unit 100 the feeding reels 110 (110a, 110b) on which band-shaped sheets Sa and Sb are wound can be arranged in parallel. Of course, although two feeding reels are illustratively shown in the present disclosure, the number and arrangement of the feeding reels are not limited thereto.

For reference, the unwinding feeding reel 110a may refer to one feeding reel that is feeding a first band-shaped sheet Sa by unwinding the first band-shaped sheet Sa among a plurality of feeding reels, while a standby feeding reel 110b may refer to the remaining feeding reel that is on standby for unwinding without currently feeding a band-shaped sheet. That is, the standby feeding reel 110b may be a reel that is disposed to be spaced apart from the unwinding feeding reel 110a and on which a second band-shaped sheet Sb on standby for replacement is wound in preparation for exhaustion of the band-shaped sheet Sa wound on the unwinding feeding reel 110a.

The present disclosure may include a first transfer roller 120a that guides transfer of a first band-shaped sheet Sa that is fed from the unwinding feeding reel 110a. The first band-shaped sheet Sa wound on the outer circumferential surface of the unwinding feeding reel 110a can be guided to the splicing unit 300 via the first transfer roller 120a. Accordingly, the first transfer roller 120a may be a driving roller that imparts a transfer force to the first band-shaped sheet Sa.

Correspondingly, the present disclosure may include a second transfer roller 120b that guides transfer of a second band-shaped sheet Sb that is fed from the standby feeding reel 110b. The second band-shaped sheet Sb wound on the outer circumferential surface of the standby feeding reel 110b can be guided to the splicing unit 300 via the second transfer roller 120b. Similar to the first transfer roller, the second transfer roller 120b may be a driving roller that imparts a transfer force to the second band-shaped sheet Sb.

Moreover, in the present disclosure, a sensor 130 may be disposed adjacent to the first transfer roller 120a. The sensor 130 detects an end-of-use time point of the first band-shaped sheet Sa that is unwound from the unwinding feeding reel 110a, and the second transfer roller 120b can be driven on the basis of a detection signal to draw out and feed a second band-shaped sheet Sb to the splicing unit 300. Optionally, the sensor 130 may be disposed adjacent to each of the first transfer roller 120a and the second transfer roller 120b.

The present disclosure includes a splicing unit 300 that connects a start end of a following second band-shaped sheet Sb to a terminal end of a preceding first band-shaped sheet Sa in order to feed an uninterrupted band-shaped sheet S.

In the present disclosure, in response to the end-of-use time point of the first band-shaped sheet Sa, the first band-shaped sheet Sa and the second band-shaped sheet Sb, which are individually fed from the unwinding unit 100, can be guided to the splicing unit 300 such that they are connected to each other.

The splicing unit 300 is configured to connect a new band-shaped sheet Sb to a band-shaped sheet Sa in use so that an uninterrupted band-shaped sheet S can be fed.

The splicing unit 300 is composed of a pair of blocks 310 and 320, and arranges the terminal end of a first band-shaped sheet Sa fed earlier and the start end of a second band-shaped sheet Sb fed subsequently in succession to the first band-shaped sheet Sa to be disposed in an overlapped manner between the pair of blocks 310 and 320. As illustrated, the pair of blocks 310 and 320 are disposed to face each other, and can control a traveling operation of a band-shaped sheet by being brought into close contact with each other or moved away from each other.

As illustrated in FIG. 5, the splicing unit 300 clamps the overlapped portion of a first band-shaped sheet Sa and a second band-shaped sheet Sb with the pair of blocks 310 and 320 each time it performs splicing, whereas, as illustrated in FIG. 1, during traveling of the first band-shaped sheet Sa, the splicing unit 300 can unclamp the first band-shaped sheet Sa by moving the pair of blocks 310 and 320 away from each other.

At least one of the pair of blocks 310 and 320 may be configured to be movable. For example, the pair of blocks 310 and 320 may be configured to be movable relative to each other, or one block 310 may be configured to be movable relative to the other block 320. Since an operation method of the blocks is already widely known, a detailed description and drawings thereof are omitted in the present specification.

As described above, the splicing unit 300 performs splicing with a first band-shaped sheet Sa and a second band-shaped sheet Sb pressed by the pair of blocks 310 and 320. A heating element 330 may be disposed in each of the blocks 310 and 320 (see FIG. 3). The splicing unit 300 can melt and join a first band-shaped sheet and a second band-shaped sheet by heating the blocks 310 and 320 by operating the heating elements 330. According to the present disclosure, band-shaped sheets S (Sa, Sb) including a thermoplastic resin such as polypropylene PP may be joined. Accordingly, the splicing unit 300 joins the terminal end of a first band-shaped sheet Sa and the start end of a second band-shaped sheet Sb to each other through high-temperature heating, whereby a band-shaped sheet S can be obtained.

Optionally, the splicing unit 300 may include needles 340 disposed on one side of the outer surface of the blocks 310 and 320 and configured to reciprocate perpendicularly or at an angle with respect to the overlapped portion of a first band-shaped sheet Sa and a second band-shaped sheet Sb (see FIG. 4). The splicing unit 300 can join the terminal end of a first band-shaped sheet and the start end of a second band-shaped sheet by entangling the ends through needle punching caused by reciprocating movement of the needles 340. According to the present disclosure, band-shaped sheets S (Sa, Sb) including a fibrous material such as a nonwoven fabric having excellent liquid absorption performance can be joined. According to the present disclosure, a plurality of through-holes 310a and 320a may be additionally formed in the thickness direction of the blocks 310 and 320 to allow the needles 340 to penetrate through the overlapped portion.

As widely known, according to the present disclosure, the terminal end of a first band-shaped sheet and the start end of a second band-shaped sheet clamped by the pair of blocks 310 and 320 may be joined by ultrasonic or laser welding, double-sided tape, or the like.

The present disclosure includes a rewinding unit 600 that takes up a band-shaped sheet S that is unwound from the unwinding unit, specifically, a spliced band-shaped sheet S.

As illustrated, the rewinding unit 600 is positioned downstream of the splicing unit 300 and can rewind and store the band-shaped sheet S that has passed through the splicing unit 300 on the outer circumferential surface of a take-up reel (not given a reference numeral).

According to the present disclosure, a buffer unit 400 is disposed on the transfer path of a band-shaped sheet S.

The buffer unit 400 is a component capable of maintaining or correcting a transfer speed of a band-shaped sheet S continuously fed by the splicing unit 300 through movement of movable rollers, and includes a plurality of fixed rollers 410 and a plurality of movable rollers 420 disposed to be displaceable relative to the plurality of fixed rollers 410.

The plurality of fixed rollers 410 are spaced apart at predetermined intervals along a traveling direction of the band-shaped sheet S. Additionally, the fixed rollers 410 may be rotatably installed.

The plurality of movable rollers 420 are positioned between the plurality of fixed rollers 410 and can reciprocate within a stroke in a direction perpendicular to a separation direction in which the fixed rollers 410 are spaced apart. Accordingly, the movable rollers 420 may be disposed to be able to approach or move away from the fixed rollers 410.

As illustrated in FIG. 1, the band-shaped sheet S travels toward a subsequent process while traveling in a serpentine manner sequentially through the fixed rollers 410 and the movable rollers 420. In particular, according to the present disclosure, a serpentine travel distance of the band-shaped sheet S can be adjusted by a roller gap between the fixed rollers 410 and the movable rollers 420 through a stroke of the movable rollers 420 from an upper limit position H to a lower limit position L.

Preferably, the present disclosure includes a cleaning unit 500 that absorbs and removes an electrolyte remaining on the electrolyte injection nozzle N by bringing the electrolyte injection nozzle N and the band-shaped sheet S into close contact with each other.

Moreover, according to the present disclosure, the cleaning unit 500 is disposed downstream of the buffer unit 400 to be able to ensure reliable contact between the electrolyte injection nozzle N and the band-shaped sheet S. According to the present disclosure, not only a predetermined transfer speed of the band-shaped sheet S that is fed to a subsequent process, but also predetermined tension can be provided through displacement of the movable rollers 420.

Optionally, according to the present disclosure, a guide unit 200 that guides a first band-shaped sheet Sa and a second band-shaped sheet Sb may be disposed between the unwinding unit 100 and the splicing unit 300.

The guide unit 200 is substantially configured as a pair disposed to face each other in parallel and is disposed adjacent to the upstream side of the splicing unit 300. Accordingly, the first and second band-shaped sheets Sa and Sb are supported by the guide unit 200 to be transported side by side between the blocks 310 and 320 of the splicing unit 300.

A recessed groove 210 may be formed on the outer surface of the guide member 200. As illustrated, the recessed groove 210 may be formed on the outer surface of the guide unit 200 along a traveling direction of a band-shaped sheet.

Since the recessed groove 210 has a T-shaped cross section, first and second band-shaped sheets Sa and Sb can be easily inserted and disposed within the recessed groove 210 and can be supported and retained without being separated from the recessed groove 210.

The operation method of the automatic feeding apparatus for a band-shaped sheet according to the present disclosure having the above-described configuration is described hereafter.

The present disclosure is configured to be able to continuously feed a band-shaped sheet from a plurality of feeding reels. Further, according to the present disclosure, on the basis of such a configuration, by continuously feeding a band-shaped sheet usable as a wiping sheet, it is possible to continuously perform a designated operation without interrupting a cleaning process of an electrolyte injection nozzle.

As illustrated in FIG. 5, the present disclosure is configured to bring a band-shaped sheet traveling from the unwinding unit 100 toward the rewinding unit 600 into contact with an electrolyte injection nozzle N so as to wipe the electrolyte injection nozzle N.

When injection of an electrolyte into a battery case through an electrolyte injection nozzle N is completed, the automatic feeding apparatus of the present disclosure can be positioned so that a band-shaped sheet S passes below the electrolyte injection nozzle N. The electrolyte injection nozzle N can cleanly wipe off the electrolyte remaining on the electrolyte injection nozzle N by coming into contact with a band-shaped sheet S that travels to be wound on the outer circumferential surface of the rewinding unit 600.

According to the present disclosure, when a first band-shaped sheet Sa that is fed from the unwinding feeding reel 110a is exhausted, it is possible to continuously feed a band-shaped sheet S to a secondary battery manufacturing process, for example, a cleaning process for an electrolyte injection nozzle by connecting a second band-shaped sheet Sb on the standby feeding reel 110b disposed at a side of the unwinding feeding reel 110a to the first band-shaped sheet Sa.

Each time a preceding first band-shaped sheet Sa and a following second band-shaped sheet Sb are spliced, the first and second band-shaped sheets Sa and Sb are clamped by the splicing unit 300, and thus a band-shaped sheet is not smoothly fed to a subsequent process.

However, according to the present disclosure, it is possible to continuously perform a cleaning process of the electrolyte injection nozzle N even while splicing of a first band-shaped sheet Sa and a second band-shaped sheet Sb is performed by the splicing unit 300. This is because, by disposing the buffer unit 400 downstream of the splicing unit 300, that is, between the splicing unit 300 and the cleaning unit 500, a band-shaped sheet S having a length longer than the length that is fed to the cleaning unit 500 can be secured at the buffer unit 400.

According to the present disclosure, a loop of a band-shaped sheet S that travels in a serpentine manner between fixed rollers 410 and movable rollers 420 constituting the buffer unit 400 is formed. While a band-shaped sheet travels to be wound on the rewinding unit 600 without being subjected to splicing, the movable rollers 420 are positioned at the upper limit position H, thereby maintaining a maximum roller gap between the fixed rollers 410 and the movable rollers 420. On the other hand, while a band-shaped sheet is spliced, the movable rollers 420 narrow the roller gap between the fixed rollers 410 and the movable rollers 420 while moving to the lower limit position L, thereby shortening the serpentine travel length of the band-shaped sheet S. Accordingly, it is possible to maintain a predetermined feed speed of the band-shaped sheet to a subsequent process (cleaning process). According to the present disclosure, when the splicing process of a band-shaped sheet is completed, the serpentine travel length of the band-shaped sheet is lengthened by moving the movable rollers 420 away from the fixed rollers 410, thereby allowing the band-shaped sheet S to be sufficiently secured inside the buffer unit 400.

Therefore, according to the present disclosure, since it is possible to continuously feed a band-shaped sheet S without interruption in a reel-to-reel manner, it is possible to continuously perform a cleaning process of an electrolyte injection nozzle N without interruption.

The present disclosure was described above in detail through detailed embodiments. Embodiments are provided to describe the present disclosure in detail, and the present disclosure is not limited thereto. It will be apparent to those skilled in the art that various modifications and improvements may be made within the spirit of the present disclosure.

All simple modifications and changes of the present disclosure are considered to fall within the scope of the present disclosure, and the specific scope of protection of the present disclosure will be clarified by the claims.

What is claimed is:

1. An automatic feeding apparatus for a band-shaped sheet, comprising:
an unwinding unit configured to feed band-shaped sheets wound on a plurality of feeding reels;
a splicing unit configured to interconnect a first band-shaped sheet wound on an unwinding feeding reel that is unwinding among the plurality of feeding reels and a second band-shaped sheet wound on a standby feeding reel that is on standby for unwinding;
a rewinding unit configured to take up a band-shaped sheet that is continuously fed by the splicing unit; and
a buffer unit disposed between the splicing unit and the rewinding unit and configured to continuously guide the band-shaped sheet that is fed from the splicing unit to a downstream side at a predetermined speed.

2. The automatic feeding apparatus of claim 1, wherein the buffer unit includes:
fixed rollers; and
movable rollers disposed to be displaceable relative to fixed rollers.

3. The automatic feeding apparatus of claim 2, wherein the fixed rollers are disposed to be spaced apart from each other along a traveling direction of the band-shaped sheet, and
the movable rollers are positioned between the fixed rollers and are disposed to be capable of reciprocating in a direction perpendicular to an arrangement direction of the fixed rollers.

4. The automatic feeding apparatus of claim 1, further comprising a cleaning unit configured to bring the band-shaped sheet transferred from the splicing unit to the rewinding unit into contact with an electrolyte injection nozzle.

5. The automatic feeding apparatus of claim 4, wherein the band-shaped sheet includes a wiping sheet configured to wipe the electrolyte injection nozzle.

6. The automatic feeding apparatus of claim 1, wherein the splicing unit is configured to join a terminal end of the first band-shaped sheet unwound from the unwinding feeding reel and a start end of the second band-shaped sheet unwound from the standby feeding reel through high-temperature heating.

7. The automatic feeding apparatus of claim 1, wherein the splicing unit is configured to join a terminal end of the first band-shaped sheet unwound from the unwinding feeding reel and a start end of the second band-shaped sheet unwound from the standby feeding reel through needle punching.

8. The automatic feeding apparatus of claim 1, wherein the unwinding unit includes:
a first transfer roller configured to guide the first band-shaped sheet unwound from the unwinding feeding reel to the splicing unit;
a second transfer roller configured to guide the second band-shaped sheet unwound from the standby feeding reel to the splicing unit; and
a sensor disposed adjacent to the first and second transfer rollers.

9. The automatic feeding apparatus of claim 1, further comprising a guide unit disposed between the unwinding unit and the splicing unit and configured to guide movement of the first band-shaped sheet and the second band-shaped sheet.
